(19) United States
(12) Patent Application Publication
(10) Pub. No.: US 2003/0038221 A1
(43) Pub. Date: Feb. 27, 2003

(54) Truck seat height positioning system

(75) Inventors: David Fu, Rochester Hills, MI (US); Robert Hazlewood, Maryville, TN (US)

Correspondence Address: FITCH EVEN TABIN AND FLANNERY, 120 SOUTH LA SALLE STREET, SUITE 1600, CHICAGO, IL, 60603-3406, US

(73) Assignee: National Seating Company

(21) Appl. No.: 10/156,854

(22) Filed: May 30, 2002

Related U.S. Application Data
(60) Provisional application No. 60/293,997, filed on May 30, 2001.

(51) Int. Cl. F16M 13/00

(52) U.S. Cl. 248/421

(57) ABSTRACT

A powered automotive seat. The powered automotive seat includes an upper seat frame and a lower seat frame. The upper seat frame is attached to the lower seat frame. The lower seat frame is attached to a suspension base assembly. The suspension base assembly includes a lower base mountable on the floor of an automotive vehicle, an upper base capable of receiving the lower seat frame and a pair of base arms attaching the upper base to the lower base. An air spring is attached between the upper base and the lower base. An automatic control unit selectively decreases and increases air pressure in the air spring. The air spring extends and contracts in response to changes in air pressure by the automatic control unit.

### CROSS REFERENCE TO RELATED APPLICATION

The present invention is related to U.S. Provisional Application No. 60/293,997, filed May 30, 2001.

### BACKGROUND OF THE INVENTION

1. Field of the Invention

The present invention is related to automatic seat positioning and adjusting devices for automotive vehicles and, more particularly, for a system and method of automatically and manually controlling truck seat position.

2. Background Description

Powered seats for vehicles including motored powered seat adjustment devices that position the seat at a selected location are well known in the art. Typically, these motor powered seat adjustment devices are used for the front seat(s) of an automobile. For small adjustments such as minor seat location and positioning adjustments, e.g., to a forward or backward location or for tilt adjustment, a small electric motor power is adequate. These power driven seats usually require a driver to sit in the seat and, manually adjust and position the seat. If the powered seat control includes storage for memorizing one or more positions, the seat can be automatically positioned for individual riders.

U.S. Pat. No. 4,401,928 to Kamijo et al. entitled “Seat Position Automatic Adjusting Device for an Automotive Vehicle” describes an example of a seat positioning automatic adjusting device for an automotive vehicle and in particular for an automobile. Kamijo et al. teaches a device that detects and stores a preselected seat location and position (e.g., lumbar support, back tilt, base tilt and forward position) as defined by seat-positioning motor-rotation counts. Each seat position is defined by a turn count for each seat degree of freedom, i.e., lumbar, back tilt, base tilt, forward position, etc. A single reversible motor sequentially drives the seat to and from a desired setting for each degree of freedom. When a memory button is pressed, the Kamijo et al. device automatically returns the seat to a previously stored setting as desired.

However, Kamijo et al. requires maintaining a current turn count for each seat degree of freedom. To move the seat to a memorized location, a number of turns must be calculated for each degree of freedom to drive the seat from one position to the next. So, each memory setting must include stored turn counts for the motor for each of the seat's degrees of freedom. Each count must also be stored and the current count maintained in order to reposition the seat. Unfortunately, if power is lost from the Kamijo et al. system, the current count may be lost. In order to recover from a power loss, the seat may have to run through a set of calibration exercises, e.g., driving from one extreme to the other, to locate the seat's present position, otherwise it may be impossible to return the seat to a memorized position. If the circuit suffers a catastrophic failure (e.g., a counter or controller failure) repositioning the seat may be impossible.

Trucks have more demanding seat location and positioning requirements than automobiles and so, motor driven power seats such as described by Kamijo et al. do not adequately meet those demands. A truck typically has much more ground clearance than an automobile and, therefore, cab entry requires the driver or a rider to climb, perhaps even using a short ladder, to enter the truck cab. Once in the cab, depending upon the cab design, e.g., steering wheel location, etc., the driver may still be required to hoist himself or herself into the driver's seat.

Thus, it may be difficult for the driver, or passenger(s) for that matter, to enter the cab with the seat situated for driving. Further, it may be impossible to position the truck seat satisfactorily both for travel or driving and for entry/exit. At every exit the driver may be forced to move the seat from a comfortable driving position (and lose that position) in order to exit or enter the truck and, then, take the time to relocate the seat in order to resume that comfortable driving position. So, for trucks or other such larger vehicles, where the seat may require much greater seat movement than the minor adjustments available on power automobile seats, other types of seat positioning drives are employed, e.g., pneumatically driven seat positioners or air spring driven seats.

Thus, there is a need for automatic powered seats for trucks that allow the driver to enter and exit the truck cab easily while maintaining a comfortable driving position for the seat.

### SUMMARY OF THE INVENTION

It is a purpose of the invention to facilitate truck cab ingress and egress;

It is another purpose of the invention to maintain seat height control even during a seat height control circuit failure.

The present invention is a powered automotive seat. The powered automotive seat includes an upper seat frame and a lower seat frame. The upper seat frame is attached to the lower seat frame. The lower seat frame is attached to a suspension base assembly. The suspension base assembly includes a lower base mountable on the floor of an automotive vehicle, an upper base capable of receiving the lower seat frame and a pair of base arms attaching the upper base to the lower base. An air spring is attached between the upper base and the lower base. An automatic control unit selectively decreases or increases air pressure in the air spring. The air spring extends or contracts in response to changes in air pressure by the automatic control unit.

### BRIEF DESCRIPTION OF THE DRAWINGS

The foregoing and other objects, aspects and advantages will be better understood from the following detailed preferred embodiment description with reference to the drawings, in which:

FIG. 1 shows a block diagram of the preferred embodiment seat height control circuit;

FIG. 2 is a side view of an example of a preferred embodiment powered seat frame;

FIGS. 3A-B show an example of a preferred embodiment suspension base;

FIG. 4 shows an example of a schematic of the control board;

FIG. 5 is an example of a solenoid driver schematic; and

FIG. 6 is an example of a schematic for an occupant sensor interface circuit.

### DESCRIPTION OF PREFERRED EMBODIMENTS OF THE INVENTION

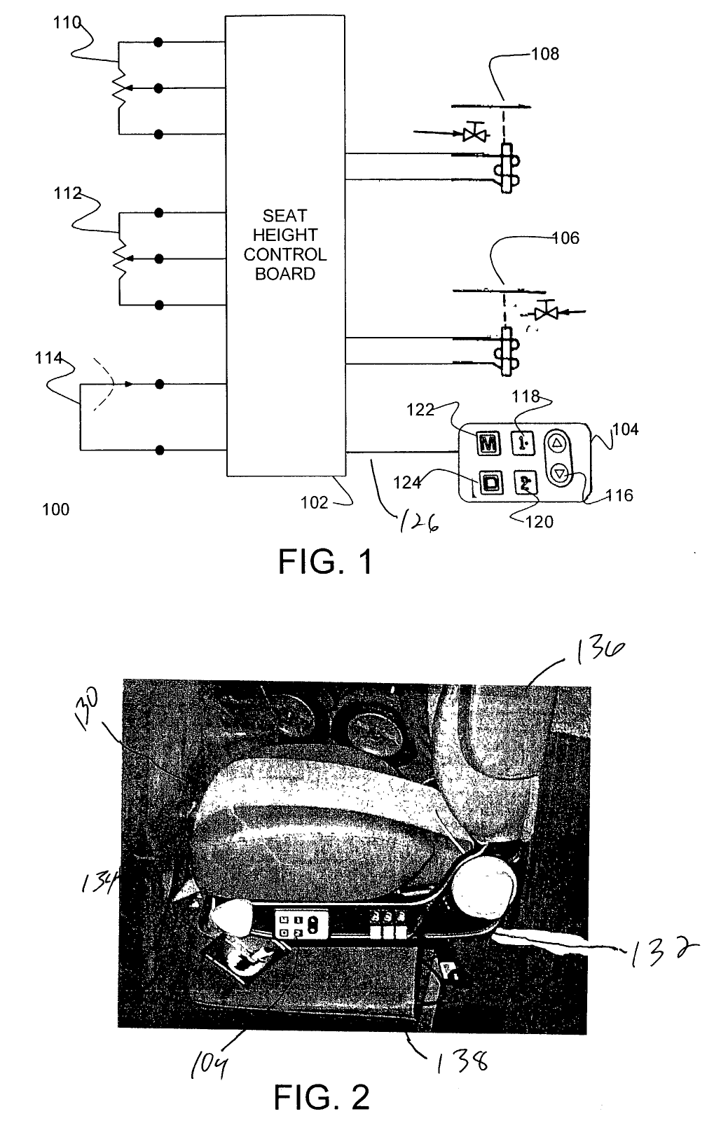

Turning now to the drawings and more particularly, FIG. 1 shows a block diagram of a preferred embodiment seat height control circuit 100. The seat height control circuit 100 includes a main seat height control module 102. The seat height control module 102 includes a microcontroller that receives and processes various inputs, e.g., from switches on a keypad 104 and/or from sensors located within the seat. In response, the microcontroller provides an appropriate output to drive a pair of air solenoid valves 106, 108, a pump solenoid and bleed solenoid. Air solenoid valves 106 and 108 selectively control air flow to/from an air spring that controls the height of an attached truck seat. Sensors may include an occupant sensor 110, a seat height sensor 112 and a tilt switch 114 that are connected to the seat height control module 102 to provide seat position and seat occupancy information. In this example, keypad 104 includes a height adjust button 116 (e.g., an up/down rocker switch), two memory switches 118, 120, a save to memory switch 122 and a manual dump switch 124. Preferably, a wiring harness 126 connects keypad 104 to control module 102. It should be noted that button and switch are used interchangeably herein and are not intended to convey unique or different meanings unless specifically set forth as such.

Preferably, occupant sensor 110 is a flexible potentiometer such as are available from Flexpoint, Inc. and located within the seat cushion. Preselected occupied/unoccupied resistances indicate whether or not the seat is occupied. So, a resistance change occurs in the occupant sensor 110 each time the occupant leaves or returns to the seat. By changing resistance in response to flexing, the occupant sensor 110 sends a high/low (threshold) signal to the electronic controller 102 in response to a weight change on the seat that indicates whether the seat is occupied or not. Whenever the occupant sensor 110 indicates that the seat is no longer occupied, (e.g., the seat occupant is exiting the cab) the seat height control module 102 energizes the bleed solenoid to drop the seat to its lowest position. When the occupant returns and the seat is reoccupied, as indicated by a reverse resistance change in the occupant sensor 110, the seat height control module 102 activates the pump solenoid to return the seat to its previous occupied position.

Tilt switch 114 gives a tip over indication, closing whenever it is tilted beyond a selected limit, i.e., indicating that the truck has turned over. The tilt sensor 114 may be mounted anywhere that may be convenient, but preferably is attached to the seat height control module 102 and contained in an enclosure for protection. If the truck tips beyond a maximum angle, e.g., 45°, and stays in that tipped position a pre-determined length of time, the sensor (tilt switch 114) sends a signal to the seat height control module 102 indicating that a vehicle tip over has occurred. In response, the seat height control module 102 opens the bleed solenoid 108 for a predetermined bleed time to retract the seat and return it to its lowest position.

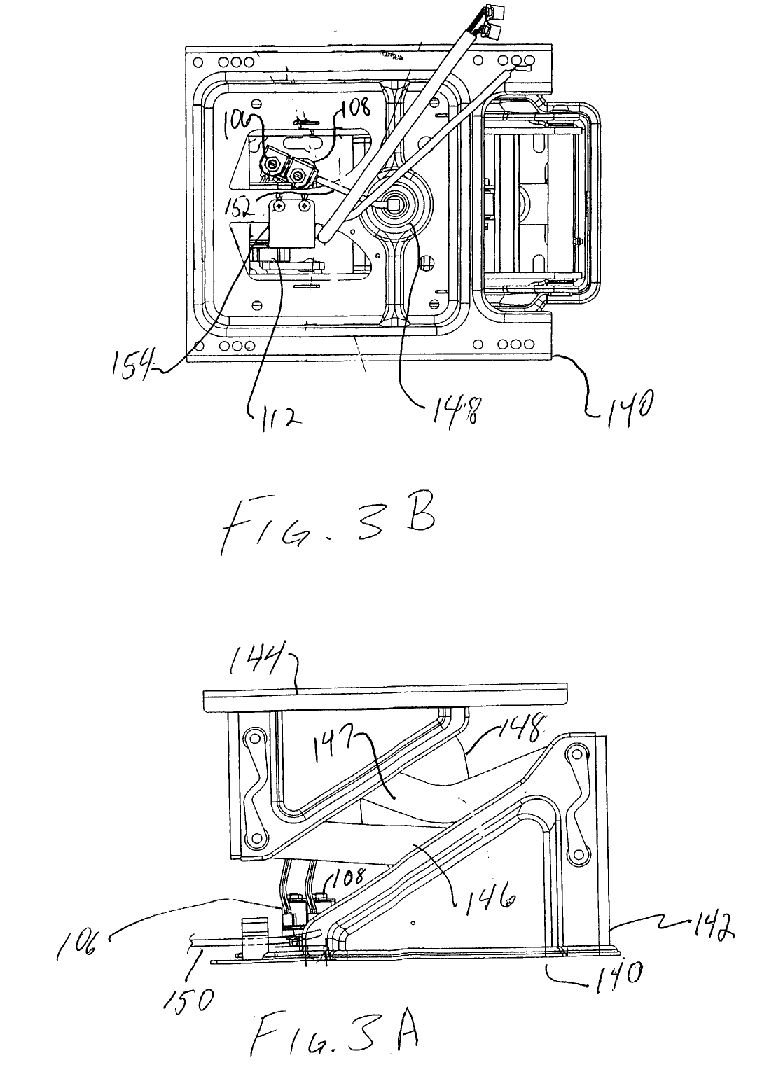

FIG. 2 is an example of a side view of a preferred embodiment powered seat frame 130. The powered seat frame 130 includes a lower frame 132, a foam seat cushion 134 and an upper seat frame 136. The powered seat frame 130 is bolted to the top of a suspension base (not shown in this Figure). The upper frame 136 (or seat back), which may include a foam seat cushion to support the occupant's back, pivots about a pivot point where the upper frame is attached to the lower frame for recline adjustment. The lower frame 132 is mounted on a suspension base concealed by apron 138 and driven by a powered suspension, e.g., an air spring. Typically, the keypad 104 is mounted at any convenient location, e.g., the side of lower frame 132, and allows the occupant to send manual control signals to the electronic controller to raise or lower the seat or to remember or recall a stored height position. As noted above, the occupancy sensor 110 is located within the seat cushion 134.

FIGS. 3A-B show a top view and a side view, respectively, of an example of a preferred embodiment suspension base 140. The suspension base 140 provides a vibration isolation mechanism and is mounted on the floor of the vehicle, supporting the seat on which an occupant may sit. The suspension base 140 moves the seat up and down in a controlled manner compensating for and in reaction to road input (e.g., bumps) and other vibrations to improve comfort and vehicle control for the driver.

The suspension base 140 includes a lower base 142, an upper base 144 and base arms 146 hingedly attaching the upper base 144 to the lower base 142. An air spring 148 is attached between lower base 142 and upper base 144. The lower base 142 attaches to the floor of the vehicle and provides the lower mounting points for the base arms 146. Upper base 144 is attached to the lower base 142, e.g., with scissor-type base arms 146, 147 or the like. In this example, the upper base 144 has upper mounting points for the base arms 146, 147 and air spring 148. Base arms 146, 147 are suspension links that allow the seat to move relative to the vehicle. Preferably, there are two pairs of base arms 146, 147 one pair on either side, both pair operating in a parallel to position the upper base 144 with respect to the lower base 142. The air spring 148 may be attached at its lower end to lower base arms 146. A shock absorber or damper (not shown) also may be mounted between upper base arms 147 and lower base arms 146.

A truck air line 150 is connected between air solenoid valves 106, 108, which are attached to the lower base. Air spring line 152 in FIG. 3B is connected between a pressurized source, e.g., a pump (not shown) and air solenoid valves 106, 108. Preferably, a single unit molded air manifold (not shown) connects truck air line 150 and air spring line 152 to air solenoid valves 106, 108. A bracket 154 attached to lower base 142 supports the control module to which seat height sensor 112 is attached. The damper (not shown), e.g., a simple shock absorber, provides a secondary suspension force for the suspension base 140 and absorbs unwanted or excessive energy by converting dynamic motion into heat that dissipates radiantly. Preferably, the damper is a fluid damper that is, essentially, a piston in an oil-filled tube.

The seat height sensor 112 is suitably situated in the suspension base 140 to determine base extension and thus, seat height. So, in this example and as indicated above, preferably, seat height sensor 112 is a rotary potentiometer. The slide of the potentiometer is rotationally operated for attachment between base arms 146 and either of the lower base 142 or the upper base 144, e.g., the upper base 144 in this example. The seat height sensor 112 provides a height proportionate voltage to the seat height control module 102 that indicates seat height. Pushing a “Save to Memory” button 118, 120 causes the seat height control module 102 either to store a value (when pushed in combination with save to memory button 122) representative of the current voltage (i.e., to memorize the current position) or, to drive the seat to a height such that the potentiometer slide voltage matches a corresponding stored value. The seat height control module 102 may be attached to the suspension base 140, e.g., hidden by and mounted on bracket 154 or, located at any appropriate place in the truck cab or otherwise on the truck.

Air solenoid valves 106, 108 operate to adjust pressure in the air spring 142 using the highest pressure air supply available, e.g., 130 psi maximum on a typical truck. The air spring 148 provides the primary suspension force for the upper base 142. Input air solenoid valve 106 receives air from truck air line 150. Input air solenoid valve 106 passes low pressure air to the air spring 148 from input air line 152. Bleed air solenoid valve 108 bleeds air from the connected air spring 148 through line 150. The air pressure in the air spring 142 creates an extensive force that balances compressive force of the seat occupant, cushioning encountered road irregularities. The occupant may operate keypad switches that open air solenoid valves 106, 108 changing air pressure in the air spring independent of the microcontroller. Increasing the air spring pressure raises the seat and makes for a firmer ride. Decreasing the air spring pressure lowers the seat and softens the ride.

Seat height may be set manually or automatically for the powered seat frame 130. When the driver (or other occupant) either, presses the rocker switch 116 to manually position the seat, uses the automatic memory buttons 118, 120 to automatically position the seat or, uses the manual dump button 124 to drop the seat to its lowest position, the control module 102 energizes the appropriate one of pump solenoid valve 106 or bleed solenoid valve 108. The driver may set the seat height manually using the up/down rocker switch 116; and, once the seat height is acceptable, the driver may select one of the two memory buttons 118, 120 to store a height value (i.e., potentiometer voltage) for the current seat height in a corresponding one of two memory locations on the seat height control module. The height voltage value represents a determinable voltage from seat height sensor 112 at the selected seat height. Pressing a preselected sequence of memory buttons 118, 120 and 122 causes new seat height value to be stored, e.g., pressing memory storage switch 122 simultaneously with either memory button 118, 120. Once a seat height value is stored in memory, the seat is automatically returned to the stored height by pressing the corresponding memory button 118 or 120 to recall the stored value. In response, the seat height control module activates the appropriate one of pump/bleed solenoid valves 106, 108 while monitoring a voltage from the seat height sensor 112. The seat is driven up or down until the seat height sensor voltage matches the stored value, indicating that the seat has returned to the selected height. Should the need arise to drop the seat to its lower limit, e.g., for an emergency exit, this is accomplished by simply pressing manual dump button 124 to open bleed solenoid valve 108, exhausting all or nearly all of the air from the air spring 148.

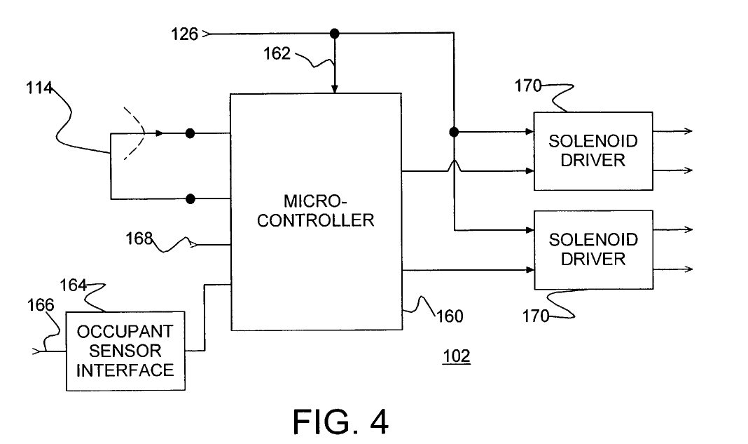

FIG. 4 shows a schematic of an example of the seat height control module 102. The seat height control module 102 includes a microcontroller 160 that receives direct input at pins 162 from wiring harness 126 connected to control buttons in the keypad. Although any general purpose microcontroller or embedded processor may be used, preferably, microcontroller 162 is a PIC16C711 microcontroller and A/D converter from Microchip Technology, Inc. As noted above, tilt switch 114 may be attached to and mounted on the control module 102 for convenience and, connected directly to an analog input of microcontroller 160. Occupant sensor 110 provides a seat occupied signal input 166 that passes through a seat occupancy sense interface circuit 164 to another analog input of the microcontroller 160. Simultaneously, the seat occupied signal is converted to a single bit binary (yes/no) signal that is passed as an interrupt to an interrupt input of microcontroller 160. The height sensor voltage is provided to yet another analog input 168 of microcontroller 160. Identical solenoid drivers 170 each drive one of pump solenoid valve 106 and bleed solenoid valve 108. Each of solenoid drivers 170 are energizable independently by either of microcontroller 160 and a respective position of the up/down switch.

With reference to FIGS. 1 and 4, switches 118, 120, 122, 124 are direct inputs 162 to microcontroller 160 only. So, if microcontroller 160 fails or is not operating satisfactorily, these switches 118, 120, 122, 124 cannot control seat position. By contrast, up/down rocker switch 116 is both an input to microcontroller 160 and directly controls seat position by connection to a respective one of the two solenoid drivers 170. Thus, seat height may be adjusted independently of microcontroller 160, i.e., even when it is defective or inoperative.

As noted above, upon entering the truck cab and sitting in the driver's seat, the driver can position the seat manually with the up/down seat height rocker switch 116. Then, the driver has the option of storing the seat height by programming a memory setting for that position. If the driver so desires, the height value is stored by pressing the memorize button 122 and memory 1 or 2 button 118, 120, simultaneously. A position voltage from the height potentiometer 112 is passed to microcontroller 160 which converts that voltage to a digital value in an internal analog to digital converter (ADC). The digital value is stored locally, preferably in on-chip storage. Then, the microcontroller 160 determines a linear height bandwidth, which is derived from calculating minimum and maximum position sensor readings. During a tipover, the microcontroller 160 overrides all other active features to retract the seat to its lowest position and stays in a SLEEP MODE, until the tilt sensor 114 indicates that the truck has been righted.

Typically, in spite of including both the air spring 148 and a damper (not shown) in the base assembly 140, the seat may shake or vibrate slightly, e.g., as a result of anomalous conditions such as bouncing after the truck hits a rock. Since normally, the seat will settle to its set height, the microcontroller 160 does not need to compensate for every variance. So, to accommodate occasionally for this type of variance, the microcontroller 160 checks the height sensor voltage from the height potentiometer 112 every two seconds to determine if the height sensor reading remains within the linear height band, i.e., that the seat is positioned and stable. Whenever the reading is not within the linear height band, the microcontroller 160 waits one additional second and then re-checks the height sensor reading. If the height potentiometer 112 reading is still outside of the linear height band at the second check, the microcontroller 160 adjusts seat height to return the seat to the correct position such that the next reading falls within the seat height band. So, if this is necessary, the microcontroller energizes one of the solenoid drivers 170 which energizes a corresponding one of air solenoid valves 106, 108 to fill or exhaust the air spring 146. The air spring 146 extends or retracts the suspension base until the seat height sensor 112 reading is returned to within the voltage range corresponding to the seat height band. The microcontroller 160 continues to monitor the height sensor 112 reading and does not initiate further adjustments as long as the seat height sensor 112 reading remains within the corresponding voltage range.

Pressing the manual dump button 124 exhausts all air in the air spring 146. When the manual dump button 146 is pressed, the microcontroller 160 initiates a subroutine for opening the air bleed solenoid valve 108 for a pre-determined time, i.e., sufficient time to exhaust air from the air spring 146, moving the seat to its lowest or retracted position. The seat remains in that retracted position until a memory switch, the manual height adjust switch is pressed or, until the driver resumes seat occupancy. This subroutine facilitates entering and exiting the cab.

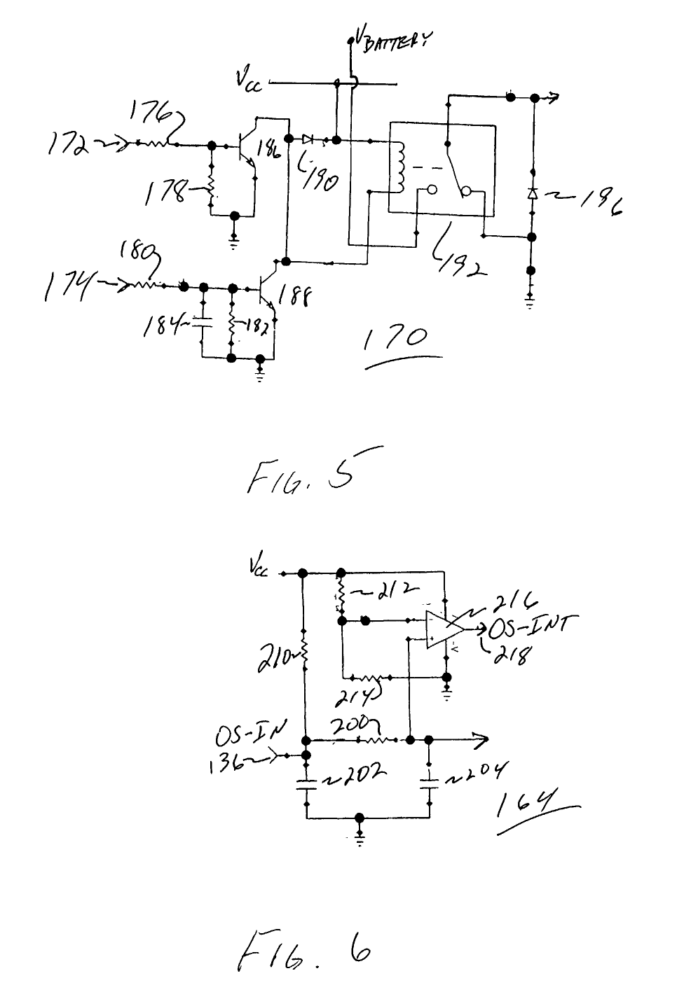

FIG. 5 is an example of a schematic for a solenoid driver 170. Each solenoid driver 170 includes a first input 172 receiving a control signal from microcontroller 160 and a second input 174 receiving an input from one side of up/down rocker switch 116 on the switch pad 104 of FIG. 1. Two pair of bias resistors 176, 178 and 180, 182 are each connected between one of the inputs 172, 174 and ground. A capacitor 184 is connected across resistor 182. The common connection of resistors 176, 178 is connected to and biases the base of transistor 186 and the common connection of resistors 180, 182 is connected to and biases the base of transistor 188. The collector of each of transistors 186, 188 is connected to the anode of clamping diode 190 and to one side of the coil of relay 192. Clamping diode 190 is connected across the coil of relay 192. The cathode of clamping diode 190 and the opposite side of the coil of relay 192 are connected to the circuit supply (V_{cc}). One pole of relay 192 is connected to the battery (12 volts) and the other pole is connected to ground, i.e., to chassis ground. The throw or switched side of relay 192 provides the output for a connected solenoid driver 170. The anode of clamping diode 194 is connected to ground and its cathode is connected to the output of the solenoid driver 170.

In normal operation, when the seat is properly positioned and stable, both inputs 172 and 174 are low and, correspondingly, both transistors 186 and 188 are, off. Since both transistors 186, 188 are off, relay 192 is not energized and ground is passed out of the relay 192 to the air solenoid valve (either of 106 or 108) being driven by relay 192. When either of inputs 172, 174 are driven high, the connected transistor 186, 188 is turned on. When transistor 186 or 188 turns on, the cathode of diode 190 and, simultaneously one side of the coil of relay 192 is pulled low to ground. Current passes through the coil between V_{cc} and ground. This energizes relay 192, which switches the throw from the grounded terminal to the battery terminal, passing battery voltage on the output of the solenoid driver 170 to the connected air valve solenoid. Capacitor 184 forms a low pass filter at the base of transistor 188 and provides noise suppression and debouncing the connected switch. Clamping diodes 190, 194 are both included to prevent overshoot/undershoot at the coil of a respective connected relay/solenoid. For rocker switch 116 to control seat height, all that is needed is: a sufficient voltage to operate the solenoids 104, 108 (V_{BATTERY}); sufficient drive voltage provided to the up/down rocker switch 116 (V_{BATTERY}) that closing the switch turns on transistor 188; and air pressure.

FIG. 6 is an example of a schematic for an occupant sensor interface circuit 124. Resistor 200 and capacitors 202, 204 form a low pass filter between the occupant sensor input 166 and analog output 206. Analog output 206 is the occupant sensor A/D input to the microcontroller 160. Resistor 210 is a bias resistor in combination with the occupant sensor, which is a flexible potentiometer as noted herein above. Resistors 212, 214 form a voltage divider tied between V_{cc} and ground that provides a reference voltage to the negative input to amplifier 216. The positive input to amplifier 216 is connected to the analog output 206. The output 218 of amplifier 216 is an interrupt input to the microcontroller 160 that indicates when an occupant has left the seat or, has returned to the seat.

When the seat is vacant, the resistance of the occupant sensor (110 in FIG. 1) is high providing a high to the positive input of sense amplifier 216 and to the connected A/D converter contained in the microcontroller 160. The high on the sense amplifier 216 provides a high out of the binary occupant sensor interrupt output 218. The high on the occupant sensor interrupt output 218 interrupts the microcontroller, which then checks the digital value at the output of the internal A/D converter and, depending upon the result of that check, lowers the seat if it determines that the seat is not occupied. When the seat is reoccupied, the resistance of the occupant sensor 110 drops, pulling the input 166 low and, correspondingly, the sense amplifier 216 positive input low. In response, the sense amplifier 216 output falls, clearing the interrupt and, the microcontroller 160 ends the occupant sensor interrupt subroutine.

Advantageously, the seat occupant can manually override the microcontroller 160. After using the memory function and auto search feature of the control board 102 to position the seat, the occupant may use the up/down seat height rocker switch 116, to change the seat height independent of the microcontroller 160. When the seat height is set manually, the microcontroller resets the seat to a default value. As described above, the up/down seat height rocker switch 116 is wired independently to the solenoid drivers 170, providing parallel redundant seat height control. So, if the microcontroller 160 malfunctions, the seat occupant can still control the seat height. Also, the seat occupant can override current height settings by selecting another pre-set memory position.

While the invention has been described in terms of preferred embodiments, those skilled in the art will recognize that the invention can be practiced with modification within the spirit and scope of the appended claims.

We claim:

1. A powered seat for a vehicle comprising an upper seat frame and a lower seat frame, the upper seat frame disposed to the rear of the lower seat frame and, the lower seat frame being attached to a suspension base assembly, the suspension base assembly comprising:
a lower base mountable on the floor of a vehicle;
an upper base capable of receiving said lower seat frame;
a pair of base arms attaching said upper base to said lower base;
an air spring attached between said upper base and said lower base; and
a control unit selectively decreasing and increasing air pressure in said air spring, said air spring extending and retracting in response to air pressure changes.

2. A powered seat for a vehicle as in claim 1, said suspension base assembly further comprising:
a first air solenoid selectively providing air to said air spring responsive to said control unit;
a second air solenoid selectively bleeding air from said air spring responsive to said control unit; and
a keypad providing control signals to said control unit, said control unit maintaining air spring extensive force and passing air to/bleeding air from said air spring responsive to inputs on said keypad.

3. A powered seat for a vehicle as in claim 2 wherein said suspension base assembly further comprises:
a height sensor sensing the distance of extension of said upper base with respect to said lower base, said height sensor providing a signal to said control unit indicating said distance, said control unit automatically maintaining air spring extensive force responsive to said signal.

4. A powered seat for a vehicle as in claim 3 further comprising an occupant sensor in said lower seat frame, said occupant sensor indicating to said control unit whether said powered seat is occupied.

5. A powered seat for a vehicle as in claim 3 further comprising a tipover sensor generating a tipover signal when said powered seat is tipped beyond a maximum angle.

6. A powered seat for a vehicle as in claim 3 wherein said control unit includes a plurality of memory locations storing seat height positions.

7. A powered seat as in claim 6 wherein said air spring is attached at one end to said base arms and at another end to said upper base.

8. A powered seat for a vehicle as in claim 7 wherein said control unit comprises:
a controller receiving input signals and providing control signals responsive to received input signals;
an occupant sensor interface circuit receiving an occupant sensor signal from an occupant sensor and providing said received signal to said controller;
a tipover sensor sensing whether said powered seat is tipped beyond a maximum angle; and
a first solenoid driver driving said first air solenoid valve and a second solenoid driver driving said second air solenoid valve, said controller providing a first control signal to each of said first solenoid driver and said second solenoid driver.

9. A powered seat for a vehicle as in claim 8 wherein each of said first solenoid driver and said second solenoid driver receives a second control signal from said keypad.

10. A powered seat for a vehicle as in claim 9 wherein said maximum angle is 45° and said keypad includes a dump button, said controller causing said second solenoid valve to bleed air from said air spring responsive to pressing said dump button, said tipover indicator indicating said powered seat has tipped beyond 45° or, said occupant sensor indicating said automotive seat is not occupied.

11. A powered seat for a vehicle as in claim 9 wherein said keypad includes a height adjust button, said seat height adjust button providing said second control signal, bypassing said controller and setting seat height.

12. A powered seat for a vehicle as in claim 7 wherein said upper seat frame is pivotally attached to said lower seat frame.

13. A powered truck seat comprising:
an upper seat frame;
a lower seat frame, said upper seat frame being disposed at the rear of said lower seat frame;
a seat cushion disposed on said lower seat frame;
an occupant sensor in said seat cushion, said occupant sensor providing an indication whether said truck seat is occupied;
a suspension base assembly, said lower seat frame being attached to said suspension base assembly, said suspension base assembly comprising:
a lower base mountable on the floor of a vehicle,
an upper base attached to and holding said lower seat frame,
a pair of base arms attaching said upper base to said lower base,
a height sensor sensing the distance of extension of said upper base with respect to said lower base, said height sensor providing a height signal,
an air spring attached between said upper base and said lower base, and
a control unit selectively decreasing and increasing air pressure in said air spring responsive to provided sensor and control signals, said air spring extending and retracting in response to air pressure changes;
a tipover sensor generating a tipover signal when said powered seat is tipped beyond a maximum angle; and
a keypad providing control signals to said control unit, said control unit maintaining air spring extensive force and passing air to/bleeding air from said air spring responsive to inputs on said keypad.

14. A powered truck seat as in claim 13, said suspension base assembly further comprising:
a first air solenoid attached to said lower base and selectively providing air to said air spring responsive to said control unit; and
a second air solenoid attached to said lower base and selectively bleeding air from said air spring responsive to said control unit.

15. A powered truck seat as in claim 14 wherein said control unit includes a plurality of memory locations selectable from said keypad and storing seat height positions.

16. A powered truck seat as in claim 15 wherein each of said first solenoid driver and said second solenoid driver receives a second control signal from said keypad.

17. A powered truck seat as in claim 16 wherein said maximum angle is 45° and said keypad includes a dump button, said controller causing said second solenoid valve to bleed air from said air spring responsive to pressing said dump button, said tipover indicator indicating said powered seat has tipped beyond 45° or, said occupant sensor indicating said automotive seat is not occupied.

18. A powered truck seat as in claim 17 wherein said keypad is mounted on said lower seat frame and includes a height adjust button, said seat height adjust button providing said second control signal, bypassing said controller and setting seat height.

19. A powered seat as in claim 18 wherein said air spring is attached at one end to said base arms and another end to said upper base.

20. A powered seat for a vehicle as in claim 19 wherein said upper seat frame is attached to said lower seat frame.
